(19) United States
(12) Patent Application Publication
(10) Pub. No.: US 2026/0260981 A1
(43) Pub. Date: Sep. 3, 2026

(54) TERMINAL SIDE-MOUNTED STARTING LEAD-ACID BATTERY

(71) Applicant: Anhui LEOCH Power Supply CORP., Huaibei (CN)

(72) Inventors: Zhenhai ZHU, Huaibei (CN); Guoliang ZHANG, Huaibei (CN); Xuliang NIU, Huaibei (CN); Qing ZHAO, Huaibei (CN)

(73) Assignee: Anhui LEOCH Power Supply CORP., Huaibei (CN)

(21) Appl. No.: 19/656,140

(22) Filed: Apr. 23, 2026

Related U.S. Application Data
(63) Continuation of application No. PCT/CN2024/117147, filed on Sep. 5, 2024.

(30) Foreign Application Priority Data
Oct. 7, 2023 (CN) 202311285442.0

(51) Int. Cl. H01M 50/172; H01M 10/12; H01M 50/147; H01M 50/186; H01M 50/514; H01M 50/548

(52) U.S. Cl. CPC H01M 50/172; H01M 10/12; H01M 50/147; H01M 50/186; H01M 50/514; H01M 50/548

(57) ABSTRACT

The present disclosure relates to the technical field of lead-acid batteries, and in particular, to a terminal side-mounted starting lead-acid battery, including a body and two sets of wiring terminals. The two sets of wiring terminals are symmetrically arranged on any two opposite end faces of the body. An extension sleeve and a sealing cover are sequentially connected along an extension direction of each of the wiring terminals. The extension sleeve is arranged concentrically with a mounting hole of the wiring terminal, a cavity is provided in the extension sleeve, a rotating shaft is rotatably connected in the cavity, a torsion spring is connected to the rotating shaft, and the other end of the torsion spring is connected to an inner wall of the cavity. The sealing cover covers an end face of the extension sleeve to close the extension sleeve.

### CROSS-REFERENCE TO RELATED APPLICATIONS

The application claims priority to Chinese patent application No. 202311285442.0, filed on October 7, 2023, the entire contents of which are incorporated herein by reference.

### TECHNICAL FIELD

The present disclosure relates to the technical field of lead-acid batteries, and in particular, to a terminal side-mounted starting lead-acid battery.

### BACKGROUND

A terminal side-mounted starting lead-acid battery refers to a battery in which terminals originally mounted on the top of the battery are transferred to the side to save space inside a vehicle.

Existing terminals are mostly covered with rubber sleeves for protection after production. However, after they are connected to wires via bolts, connection points are often directly exposed to the outside. Since the bolts are conductors, exposure to the outside poses certain potential safety hazards. Moreover, the bolts exposed to the outside for a long time are prone to dust accumulation or corrosion, which hinders subsequent disassembly.

### SUMMARY

With respect to the problems in the prior art, the present disclosure provides a terminal side-mounted starting lead-acid battery. A specific technical solution is as follows:

A terminal side-mounted starting lead-acid battery, including a body and two sets of wiring terminals, the two sets of wiring terminals being symmetrically arranged on any two opposite end faces of the body, wherein an extension sleeve and a sealing cover are sequentially connected along an extension direction of each of the wiring terminals, wherein

the extension sleeve is arranged concentrically with a mounting hole of the wiring terminal, a cavity is provided in the extension sleeve, a rotating shaft is rotatably connected in the cavity, a torsion spring is connected to the rotating shaft, and the other end of the torsion spring is connected to an inner wall of the cavity;

the sealing cover covers an end face of the extension sleeve to close the extension sleeve, and the other end of the rotating shaft is connected to the sealing cover; and

the sealing cover is driven by an external force to rotate about the rotating shaft to open the extension sleeve, and after the external force is removed, is driven by the torsion spring to return.

As a further technical solution of the present disclosure, the extension sleeve is provided with a notch, and a size of the notch matches that of a wire.

As a further technical solution of the present disclosure, a sliding cavity is provided in the extension sleeve, a clamping block is slidably connected in the sliding cavity, one end of the clamping block extends through the sliding cavity into the notch, and a spring is arranged between an inner wall of the sliding cavity and the clamping block, the spring being in a compressed state and driving the clamping block to clamp the wire.

As a further technical solution of the present disclosure, a pull cord is connected to an end of the clamping block away from the notch, and the other end of the pull cord is connected to the rotating shaft; and

the clamping block is driven by the rotating shaft to release sealing of the notch when the extension sleeve is opened, and to return to clamp the wire when the extension sleeve is closed.

As a further technical solution of the present disclosure, a rubber pad is provided on an end face of the clamping block in contact with the wire.

The present disclosure achieves the following beneficial effects:
(1) Continuous protection for connection points can be automatically formed after the terminals are mounted, which prevents exposure of the connection points to the outside, reduces potential safety hazards, and also prolongs the service life of mounting parts, thereby facilitating subsequent disassembly and maintenance.
(2) The wire is placed at the notch, which can continuously clamp and protect the wire and be adapted to wires of different sizes, thereby improving applicability of the apparatus.
(3) The extension sleeve and the notch can be opened simultaneously with one operation during the mounting, and the extension sleeve and the notch can be automatically closed after the mounting. Under the premise of ensuring convenience of the mounting, automatic sealing in a normal state is achieved, which ensures a protective effect on terminal connection points.

### BRIEF DESCRIPTION OF DRAWINGS

FIG. 1 shows a schematic diagram of an overall structure of a terminal side-mounted starting lead-acid battery;

FIG. 2 shows a schematic diagram of a cross-sectional structure of a cavity;

FIG. 3 shows a schematic diagram of a cross-sectional structure of an extension sleeve; and

FIG. 4 shows a schematic structural diagram of a state in FIG. 3.

Description of reference numerals: 100: body; 200: wiring terminal; 310: extension sleeve; 311: cavity; 312: rotating shaft; 313: torsion spring; 314: notch; 315: sliding cavity; 316: clamping block; 317: spring; 318: pull cord; 320: sealing cover.

### DETAILED DESCRIPTION OF THE EMBODIMENTS

In order to make the objectives, technical solutions, and advantages of the embodiments of the present disclosure clearer, the technical solutions of the present disclosure will be clearly and completely described below with reference to embodiments.

Existing terminals are mostly covered with rubber sleeves for protection after production. However, after they are connected to wires via bolts, connection points are often directly exposed to the outside. Since the bolts are conductors, exposure to the outside poses certain potential safety hazards. Moreover, the bolts exposed to the outside for a long time are prone to dust accumulation or corrosion, which hinders subsequent disassembly.

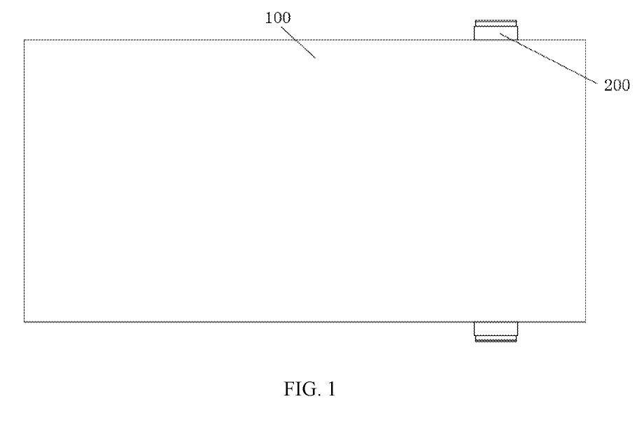

With respect to the above technical problems, the present application provides a terminal side-mounted starting lead-acid battery. FIG. 1 shows a schematic diagram of an overall structure of a terminal side-mounted starting lead-acid battery.

In FIG. 1, the terminal side-mounted starting lead-acid battery includes a body 100 and two sets of wiring terminals 200, and the two sets of wiring terminals 200 are symmetrically arranged on any two opposite end faces of the body 100.

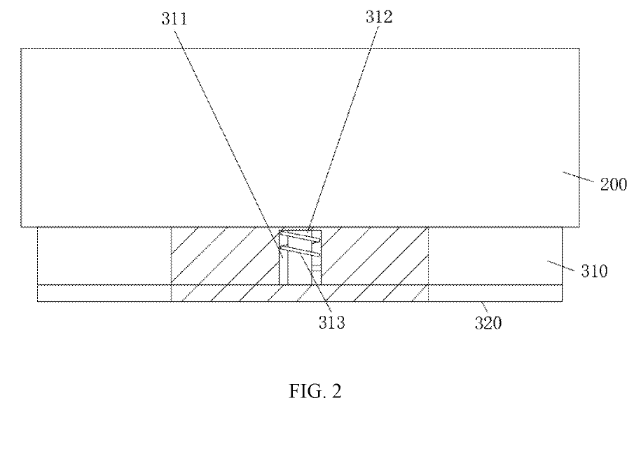

FIG. 2 shows a schematic diagram of a cross-sectional structure of a cavity. In FIG. 2, an extension sleeve 310 and a sealing cover 320 are sequentially connected along an extension direction of each wiring terminal 200.

The extension sleeve 310 is arranged concentrically with a mounting hole of the wiring terminal 200, a cavity 311 is provided in the extension sleeve 310, a rotating shaft 312 is rotatably connected in the cavity 311, a torsion spring 313 is connected to the rotating shaft 312, and the other end of the torsion spring 313 is connected to an inner wall of the cavity 311.

The sealing cover 320 covers an end face of the extension sleeve 310 to close the extension sleeve 310, and the other end of the rotating shaft 312 is connected to the sealing cover 320.

The sealing cover 320 is driven by an external force to rotate about the rotating shaft 312 to open the extension sleeve 310, and after the external force is removed, returns under an elastic force of the torsion spring 313.

In specific use, the sealing cover 320 is driven by the elastic force of the torsion spring 313 to continuously close the extension sleeve 310. During the mounting, an external force is applied to the sealing cover 320 to drive the sealing cover 320 to rotate about the rotating shaft 312. In this case, the extension sleeve 310 is opened, and the torsion spring 313 is deformed, so a terminal connection can be made. After the connection is completed, the external force applied to the sealing cover 320 is removed, and the elastic force of the torsion spring 313 may drive the sealing cover 320 to return, which re-seals a terminal connection point. With this structure, continuous protection for connection points can be automatically formed after the terminals are mounted, which prevents exposure of the connection points to the outside, reduces potential safety hazards, and also prolongs the service life of mounting parts, thereby facilitating subsequent disassembly and maintenance.

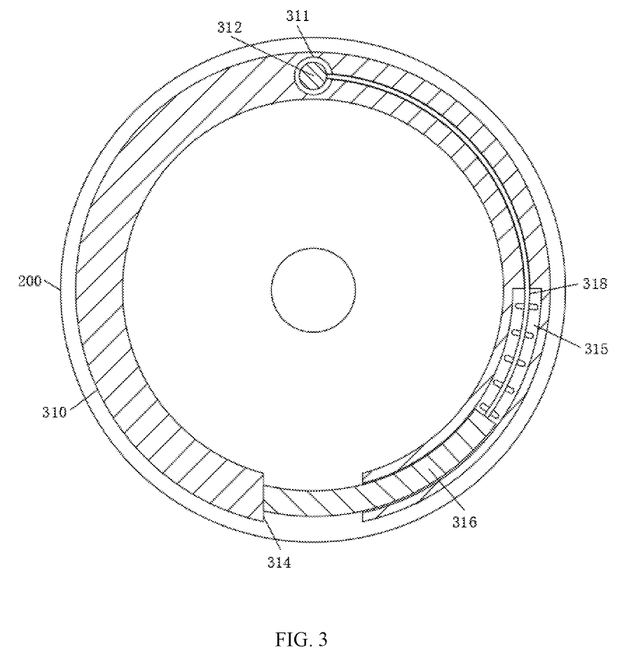

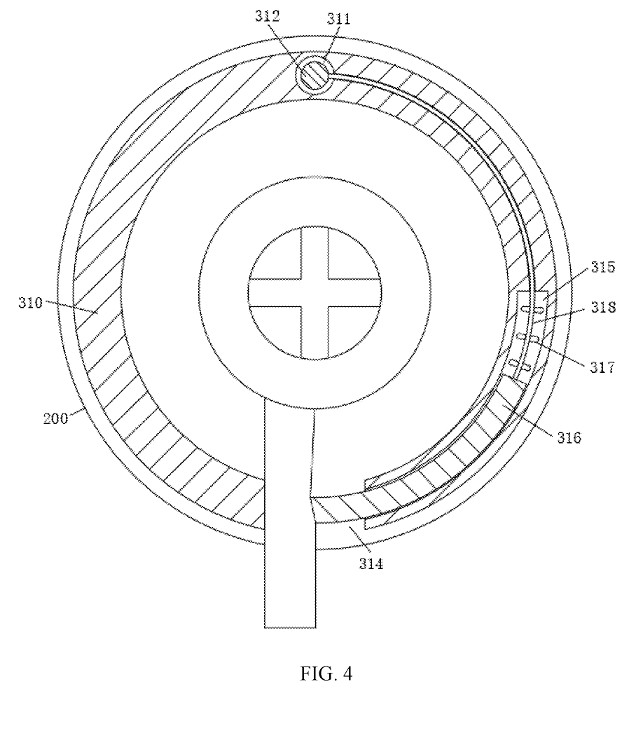

FIG. 3 shows a schematic diagram of a cross-sectional structure of the extension sleeve 310. FIG. 4 shows a schematic structural diagram of a state in FIG. 3. In FIG. 3 and FIG. 4, the extension sleeve 310 is provided with a notch 314, and the size of the notch 314 matches that of a wire.

In specific use, after the terminal is mounted, the wire may be placed into the notch 314 for leading out, as shown in FIG. 4. The design may complete placement of the wire while ensuring sealing performance of the protection.

Refer to FIG. 3 and FIG. 4. A sliding cavity 315 is provided in the extension sleeve 310, a clamping block 316 is slidably connected in the sliding cavity 315, one end of the clamping block 316 extends through the sliding cavity 315 into the notch 314, a spring 317 is arranged between an inner wall of the sliding cavity 315 and the clamping block 316, and the spring 317 is in a compressed state and drives the clamping block 316 to clamp the wire.

In use, an external force is applied to drive the clamping block 316 to enter the sliding cavity 315, and then the wire is placed at the notch 314. When the external force is removed, the clamping block 316 returns and clamps the wire. With this structure, wires of different sizes can be adapted to, thereby improving applicability of the apparatus.

Referring to FIG. 3 and FIG. 4, a pull cord 318 is connected to an end of the clamping block 316 away from the notch 314, and the other end of the pull cord 318 is connected to the rotating shaft 312.

The clamping block 316 is driven by the rotating shaft 312 to release sealing of the notch 314 when the extension sleeve 310 is opened, and to return to clamp the wire when the extension sleeve 310 is closed.

In use, when the sealing cover 320 rotates about the rotating shaft 312, the rotating shaft 312 rotates synchronously and winds the pull cord 318 around a surface thereof, thereby pulling the clamping block 316 into the sliding cavity 315 to release the sealing of the notch 314. In this case, the extension sleeve 310 and the notch 314 are opened synchronously. After the sealing cover 320 returns, the rotating shaft 312 rotates in an opposite direction and releases traction on the clamping block 316. In this case, the clamping block 316 is driven by a compression force of the spring 317 to return, and the extension sleeve 310 and the notch 314 are closed synchronously. With this structure, the extension sleeve 310 and the notch 314 can be opened or closed synchronously, improving integrity of the apparatus.

A rubber pad is provided on an end face of the clamping block 316 in contact with the wire.

When the clamping block 316 squeezes the wire, the rubber pad is squeezed and deforms. On the one hand, the wire is protected, and on the other hand, the deformed rubber pad fills a gap between the notch 314 and the wire, improving a sealing effect.

The above embodiments are intended only to illustrate, not to limit, the technical solutions of the present disclosure.

What is claimed is:

1. A terminal side-mounted starting lead-acid battery, comprising a body (100) and two sets of wiring terminals (200), the two sets of wiring terminals (200) being symmetrically arranged on any two opposite end faces of the body (100), wherein an extension sleeve (310) and a seal cover (320) are sequentially connected along an extension direction of each of the wiring terminals (200), wherein
the extension sleeve (310) is arranged concentrically with a mounting hole of the wiring terminal (200), a cavity (311) is provided in the extension sleeve (310), a rotating shaft (312) is rotatably connected in the cavity (311), a torsion spring (313) is connected to the rotating shaft (312), and the other end of the torsion spring (313) is connected to an inner wall of the cavity (311);
the sealing cover (320) covers an end face of the extension sleeve (310) to close the extension sleeve (310), and the other end of the rotating shaft (312) is connected to the sealing cover (320); and
the sealing cover (320) is driven by an external force to rotate about the rotating shaft (312) to open the extension sleeve (310), and after the external force is removed, is driven by the torsion spring (313) to return.

2. The terminal side-mounted starting lead-acid battery according to claim 1, wherein the extension sleeve (310) is provided with a notch (314), and a size of the notch (314) matches that of a wire.

3. The terminal side-mounted starting lead-acid battery according to claim 2, wherein a sliding cavity (315) is provided in the extension sleeve (310), a clamping block (316) is slidably connected in the sliding cavity (315), one end of the clamping block (316) extends through the sliding cavity (315) into the notch (314), and a spring (317) is arranged between an inner wall of the sliding cavity (315) and the clamping block (316), the spring (317) being in a compressed state and driving the clamping block (316) to clamp the wire.

4. The terminal side-mounted starting lead-acid battery according to claim 3, wherein a pull cord (318) is connected to an end of the clamping block (316) away from the notch (314), and the other end of the pull cord (318) is connected to the rotating shaft (312); and
the clamping block (316) is driven by the rotating shaft (312) to release sealing of the notch (314) when the extension sleeve (310) is opened, and to return to clamp the wire when the extension sleeve (310) is closed.

5. The terminal side-mounted starting lead-acid battery according to claim 3, wherein a rubber pad is provided on an end face of the clamping block (316) in contact with the wire.
